(19) United States
(12) Patent Application Publication
(10) Pub. No.: US 2009/0016301 A1
(43) Pub. Date: Jan. 15, 2009

(54) PACKET DATA CONVERGENCE PROTOCOL OPERATIONS

(75) Inventors: Mohammed Sammour, Montreal (CA); Stephen E. Terry, Northport, NY (US); Peter S. Wang, East Setauket, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/169,231

(22) Filed: Jul. 8, 2008

Related U.S. Application Data
(60) Provisional application No. 60/949,095, filed on Jul. 11, 2007.

(51) Int. Cl. H04Q 7/20

(52) U.S. Cl. 370/331

(57) ABSTRACT

The application discloses techniques for determining where to locate and how to fit the duplicate detection functionality within the PDCP architecture as well as determining when to activate or deactivate various PDCP functions, such as the PDCP reordering function. These mechanisms can be implemented in wireless devices such as a WTRU, or in any wireless network nodes.

### CROSS REFERENCE TO RELATED APPLICATIONS

This application claims the benefit of U.S. provisional application No. 60/949,095, filed Jul. 11, 2007, which is incorporated by reference as if fully set forth.

### FIELD OF INVENTION

This application relates to wireless systems that utilize a packet data convergence protocol (PDCP) sublayer, such as the Third generation partnership project (3GPP) long term evolution (LTE) and/or high speed packet access (HSPA).

### BACKGROUND

The long term evolution (LTE) of the Third Generation Partnership Protocol (3GPP) has defined a user-plane protocol stack architecture as shown in FIG. 1, that includes the Layer 2 (L2) sub layers: packet data convergence protocol (PDCP), radio link control (RLC) and medium access control (MAC).

In 3GPP, the main services and functions of the PDCP sublayer include:
Header compression and decompression: robust header compression (ROHC) only;
Transfer of user data: transmission of user data means that PDCP receives PDCP system data unit (SDU) from the non access stratum (NAS) and forwards it to the RLC layer and vice versa;
Reordering of the downlink RLC SDUs at least during inter-evolved Node-B (eNB) mobility;
In-sequence delivery of upper layer PDUs at HO in the uplink (FFS);
Duplicate detection of lower layer SDUs;
Ciphering of user plane data and control plane data (NAS Signaling);

According to 3GPP, the Packet Data Convergence Protocol (PDCP) supports the following functions:
header compression and decompression of IP data flows (using the ROHC protocol, FFS) at the transmitting and receiving entity, respectively.
   transfer of data (user plane or radio resource control (RRC) data). This function is used for conveyance of data between users of PDCP services.
   maintenance of PDCP sequence numbers for radio bearers.
   in-sequence delivery of upper layer protocol data unit (PDU)s at handover (HO);
   duplicate detection of lower layer SDUs;
   ciphering and deciphering of user plane data and control plane data;
   integrity protection of control plane data

FIG. 2 depicts the PDCP PDU structure which consists of PDCP SDU and a PDCP header, and the PDCP header may be either 1 or 2 bytes long.

COUNT
For ciphering and integrity, a COUNT value is maintained. The COUNT value is composed of a Hyper Frame Number (HFN) and the Sequence Number (SN) as shown in FIG. 3. The SN is transmitted in each PDCP packet (e.g. the PDCP SN), while the HFN is not transmitted in each packet but rather maintained locally. The size of the HFN part depends on the size of the SN. The COUNT is constructed (assigned) at the PDCP receiver (e.g. in the WTRU) from the received PDCP SN and the locally stored HFN i.e. a COUNT assignment function exists at the PDCP receiver.

For PDCP layering, the PDCP entity at the receiver will perform reordering 30 after performing deciphering 20 and decompression 10 at the receiver, as in Option 3 shown in FIG. 4. Alternatively, as in Option 1, the receiver performs decompression 10 after reordering 30 followed by deciphering 20 or, as in Option 2, the receiver performs decompression 10 after deciphering 20 followed by reordering 10.

Mechanisms for locating and fitting the “duplicate detection of lower layer SDUs” function into the PDCP layering architecture in an efficient and effective manner, especially in relation to the other functions that exist in the PDCP layer are desirable. Techniques for generating indications/triggers to be utilized by the various PDCP functions such as reordering and/or duplicate detection and/or any other PDCP function are also desirable in the LTE environment. Mechanisms for efficiently activating and deactivating the PDCP reordering function need are also desirable.

### SUMMARY

Techniques for determining where to locate and how to fit the duplicate detection functionality within the PDCP architecture as well as determining when to activate or deactivate various PDCP functions, such as the PDCP reordering function are disclosed. These mechanisms may be implemented in wireless devices such as a WTRU, or in wireless network nodes.

### BRIEF DESCRIPTION OF THE DRAWINGS

A more detailed understanding may be had from the following description, given by way of example in conjunction with the accompanying drawings wherein:

FIG. 1 shows a LTE user-plane protocol stack;

FIG. 2 shows a PDCP PDU Structure;

FIG. 3 shows a format of a COUNT information element;

FIG. 4 shows possible locations for the PDCP reordering function;

FIG. 5 shows alternative locations for the duplicate detection functionality within the WTRU PDCP receiver;

FIG. 6 is a signaling diagram showing an example embodiment;

FIG. 7 is a signaling diagram showing another embodiment;

FIG. 8 is a signaling diagram showing another embodiment; and

FIG. 9 shows an example device in which the disclosed embodiments may be implemented.

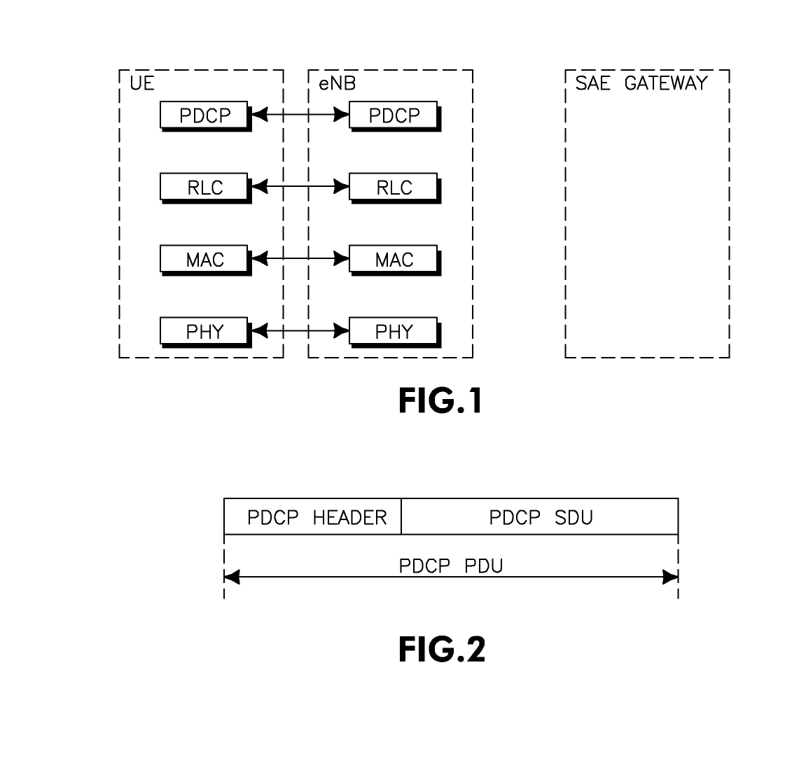

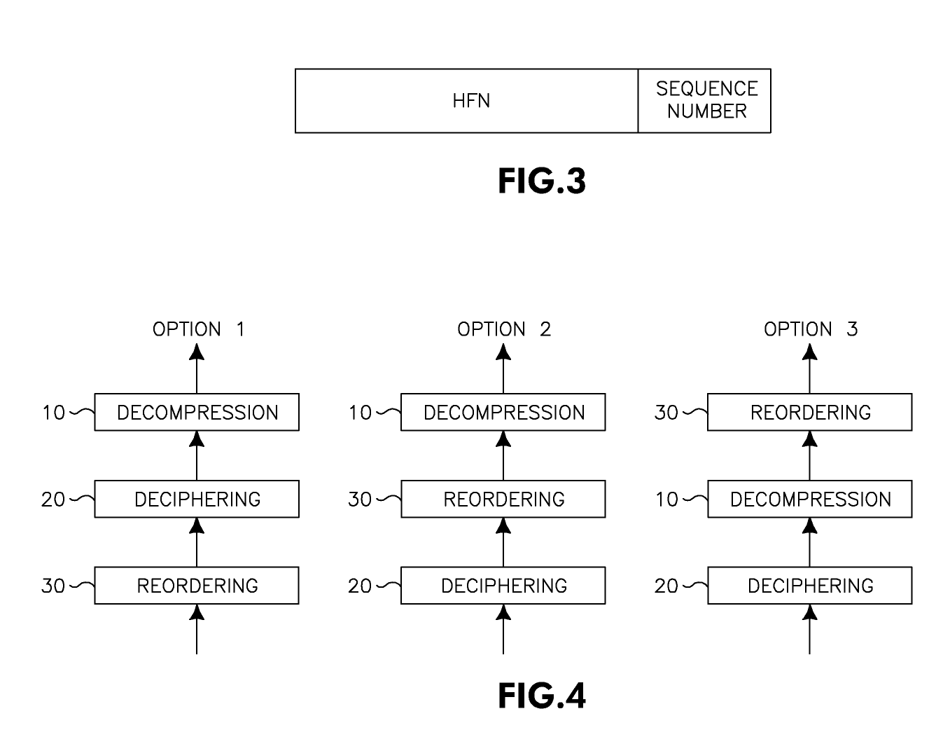

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, eNB, a site controller, an access point (AP), or any other type of interfacing device capable of operating in a wireless environment. When referred to hereafter, the term eNB refers to any of the following: Evolved Universal Terrestrial Radio Access Network (UTRAN) Node-B, E-UTRAN Node-B, evolved Node-B. When referred to hereafter, the term PDCP refers to any of the following: a PDCP entity, the PDCP sublayer or PDCP functions/protocol.

It should be noted that although some variables are referred to such as Rx_PDCP_SN at multiple places and within different algorithms, such variables may either be independent from each other (although referenced by the same variable name in different functions), or alternatively may be shared between different PDCP functions.

Although functions are described within different sections below, it is possible to combine, merge or apply some of the concepts/methods described in certain sections for the purposes of other sections. Some of the algorithms described in this disclosure may also be applied in other scenarios, in different circumstances, or to solve other problems in addition to those described in this disclosure.

The following describes embodiments for locating the packet duplication detection function within the PDCP layer. Other aspects of the PDCP layer described herein may or may not be used with these locations for the packet duplicate detection function. “Duplicate detection of lower layer SDUs” is a function of PDCP. The embodiments below include three example alternatives for performing the duplicate detection function within the PDCP sublayer.

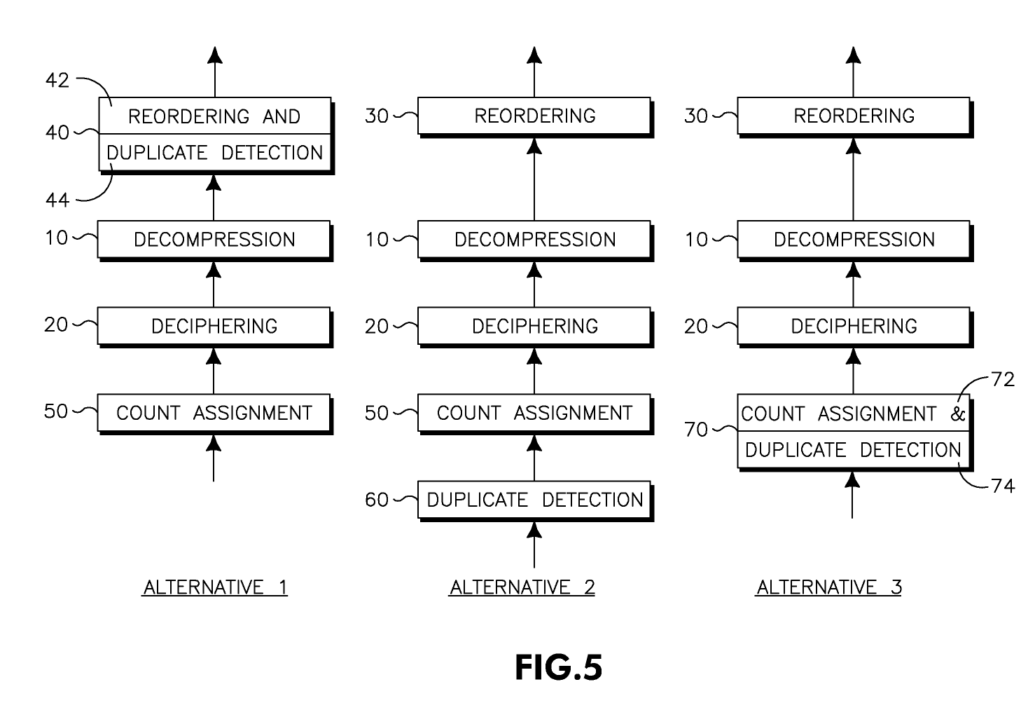

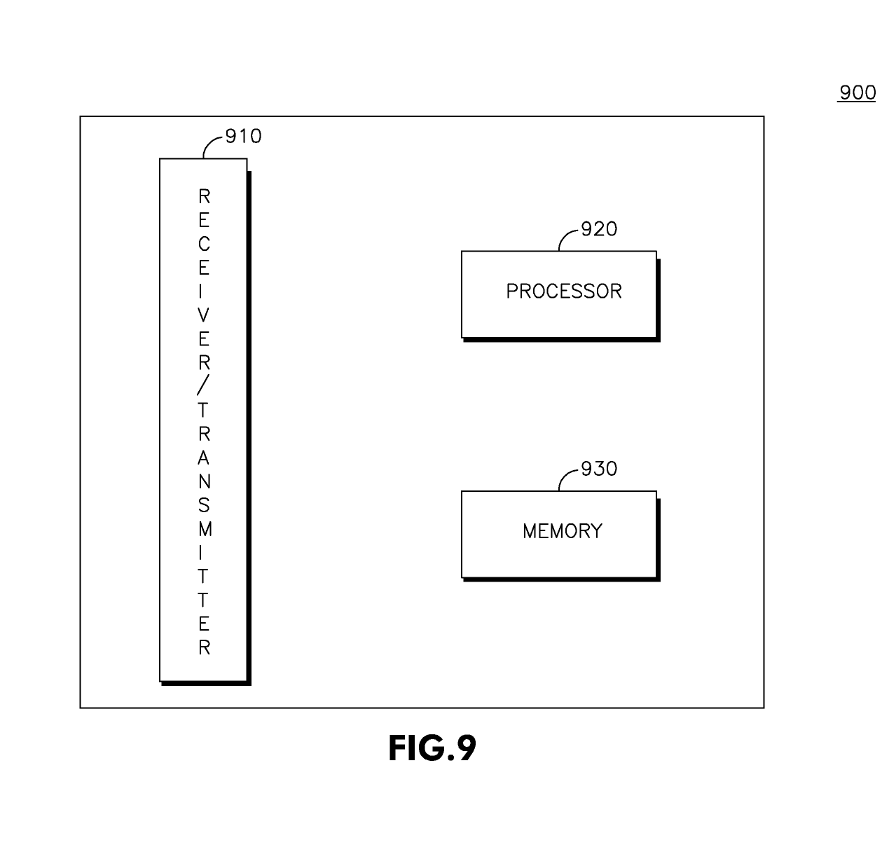

FIG. 5 illustrates the three alternatives (embodiments), by building on Option 3 of FIG. 4. FIG. 5 also shows the COUNT Assignment operation 50 which is performed prior to the deciphering function 20. The procedures, shown in FIG. 5, may be implemented in software (and/or firmware, hardware, etc.) in a device such as the WTRU 900 shown in FIG. 9.

In a first embodiment (Alternative 1 in FIG. 5), the duplicate detection function 44 is performed at or near the top of the Rx PDCP sublayer, preferably in conjunction 40 with the reordering function 42. The processor 920, shown in FIG. 9, will perform the procedures shown in FIG. 5. The processor 920 will determine the COUNT 50 first, then perform deciphering 20, then perform header decompression 10, then perform duplicate detection and reordering 40 (44 duplicate detection and 42 reordering, respectively).

In a second embodiment (Alternative 2 in FIG. 5), the duplicate detection function 60 is performed at or near the bottom of the Rx PDCP sublayer, preferably before the COUNT assignment function 50. In this embodiment, the processor 920, shown in FIG. 9, will perform duplicate detection 60 first, then it will determine the COUNT 50, then deciphering 20, then header decompression 10, and then it will perform reordering 30.

In a third embodiment (Alternative 3 in FIG. 5), the duplicate detection function 74 is performed at or near the bottom of the Rx PDCP sublayer, preferably in conjunction 70 with the COUNT determination function 72. The processor 920, shown in FIG. 9, will perform duplicate detection and determine the COUNT 70 (74 duplicate detection and COUNT 72, respectively), then it will perform deciphering 20, then header decompression 10, and then it will perform reordering 30.

In the second and third embodiments, the duplicate detection function (60 and 74 respectively) can discard duplicates early eliminating the need to apply deciphering and/or decompression on packets that will ultimately be discarded. Also, such alternatives may simplify the COUNT assignment operation (50 and 70 respectively).

Additional embodiments that perform duplicate detection at the PDCP receiver are disclosed below.

Variables/Parameters:
PDCP_SN: The received PDU includes the PDCP_SN which is the SN of the received PDCP packet.
WTRU Receive Variables:
   Rx_PDCP_SN: The SN expected for the next PDCP packet to be received.
   Rx_Status[SN]=Indicates whether the packet having such SN was already received or not; initially, Rx_Status[SN]=‘Not Received’ for all SN's;

In this embodiment, the duplicate detection method will utilize the PDCP SN of the received packet to determine whether the PDCP sublayer's buffer stores something at such PDCP SN; if so, the packet is discarded; if not, the packet is accepted. The following illustrates the operation:

If (Rx_Status[PDCP_SN]==‘Not Received’;
Accept (i.e. store) packet;
Rx_Status[PDCP_SN]=‘Received’;

Else
Discard packet;

The following describes embodiments for providing indications to be utilized as triggers for PDCP functions. Other aspects of the PDCP layer described herein may or may not use these indications/triggers. Certain PDCP functions take handover (inter-eNB mobility) into account either directly or indirectly. For example, in 3GPP “Reordering of the downlink RLC SDUs at least during inter-eNB mobility” and “In-sequence delivery of upper layer PDUs at HO” are functions in the PDCP sub-layer.

Additionally, the deciphering COUNT assignment/construction algorithm may also need to take handover (inter-eNB mobility) into account either directly or indirectly.

In another embodiment, a variety of indications may be utilized to trigger the functions within PDCP, such as indicating when to start or stop the PDCP reordering function, COUNT assignment function, or any other function. These indications may be implemented as primitives, signals, messages, events, or in any other form.

The indications that are described may be sent directly to the PDCP sublayer, or may be sent indirectly to the PDCP sublayer via another layer that generates another subsequent indication: as an example, the RRC layer may generate indications to the PDCP sublayer based on indications that the RRC layer receives.

Described below are two classes or types of indications:
Type A indications, such as an indication that inter-eNB mobility (e.g. handover) has started or is about to start.
Type B indications, such as an indication that inter-eNB mobility (e.g. handover) has completed.

Although these indications are described in the context of a mobility scenario, they are also applicable and may be utilized during other scenarios that are not tied to inter-eNB mobility (e.g. handover).

Although a given indication may be classified as Type A or Type B, some Type A indications may also be suitable as (serve as) Type B indications, and vice versa.

Type A indications that are handover or RRC related may include one or more of the following:
Indication of the WTRU reception of the Handover Command message
Indication that the WTRU is in an inter-eNB mobility state (e.g. HO in progress)
Any other indication signifying that HO (e.g. inter-eNB mobility) is about to occur

Type A indications that are RLC related may include one or more of the following:
Indication of initiating RLC reset
Indication of initiating RLC re-establishment
Indication of RLC flushing (its reordering buffer) and/or forwarding the packets it had in its buffer
Indication of RLC timing out on missing PDUs (i.e. SN gaps)
Indication of RLC receiving MRW command
Indication of RLC out-of-sequence delivery to upper layers due to HO
Indication of suspension of RLC in-sequence delivery to upper layers due to HO
Indication of RLC out-of-sequence delivery to upper layers due to reset or reestablishment
Indication of suspension of RLC in-sequence delivery to upper layers due to reset or reestablishment
Indication of RLC out-of-sequence delivery to upper layers (due to any reason)
Indication of suspension of RLC in-sequence delivery to upper layers (due to any reason)

Type B indications that are handover (HO) or RRC related may include one or more of the following:
Indication of the WTRU sending of the Handover Confirm message (or equivalently the indications that cause the Handover Confirm message to be sent)
Indication that the WTRU successfully accessed the target cell
Indication that the WTRU has exited the inter-eNB mobility state (e.g. HO completed)
Any other event indicating that HO (e.g. inter-eNB mobility) is complete

Type B indications that are RLC related may include one or more of the following:
Indication of successful or completed RLC reset
Indication of successful or completed RLC re-establishment
Indication of RLC in-sequence delivery to upper layers after HO (i.e. in the target eNB)
Indication of RLC in-sequence delivery to upper layers after reset or reestablishment
Indication of RLC in-sequence delivery to upper layers (at any time)

Type B indications that are PDCP related may include one or more of the following:
Indication that PDCP SN source cell gaps have been filled (i.e. with target transmissions)

In one embodiment, a “Type A indication” (described in earlier section) is used to activate the PDCP reordering function.

In another embodiment, a “Type B indication” (described above) is used to deactivate the PDCP reordering function.

Examples of Type B indications that may also be suitable as (serve as) Type A indications, and hence may be used to activate the PDCP reordering function are:
Indication of successful or completed RLC reset
Indication of successful or completed RLC re-establishment
Indication of the WTRU sending of the Handover Confirm message (or equivalently the indications that cause the Handover Confirm message to be sent)
Indication that the WTRU successfully accessed the target cell

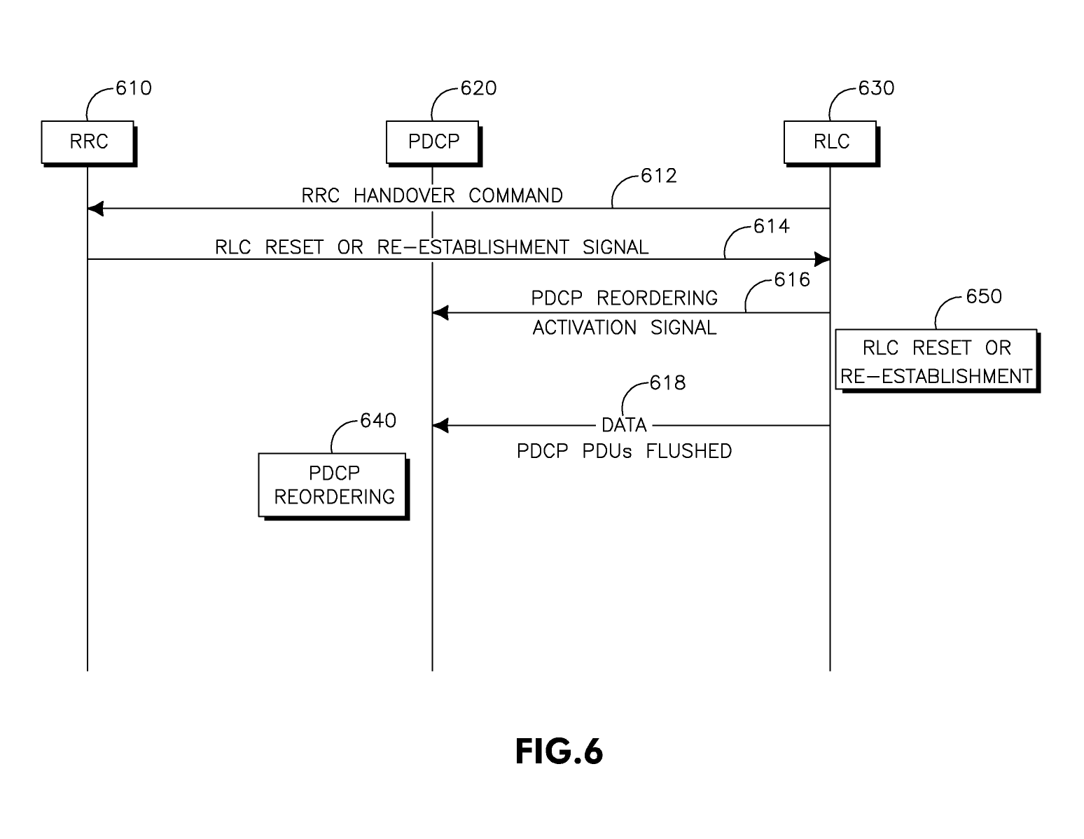

The following is a first embodiment for reordering activation. As shown in FIG. 6, in this embodiment which may be implemented in a device such as the WTRU 900 shown in FIG. 9, the RRC 610 receives the HO Command 612 which subsequently invokes an RLC reset (or re-establishment) 614, and the RLC 630 forwards PDCP PDUs in the RLC buffer up to the PDCP 620 (such PDCP PDUs may be out of sequence or in sequence) by flushing the RLC buffer at 618 and the PDCP Reordering function 640 is simultaneously signaled to activate by Signal 616 (e.g. a PDCP Reordering Activation Signal). The Signal 616 may also be received by the PDCP 620 before the RLC begins forwarding PDCP PDUs.

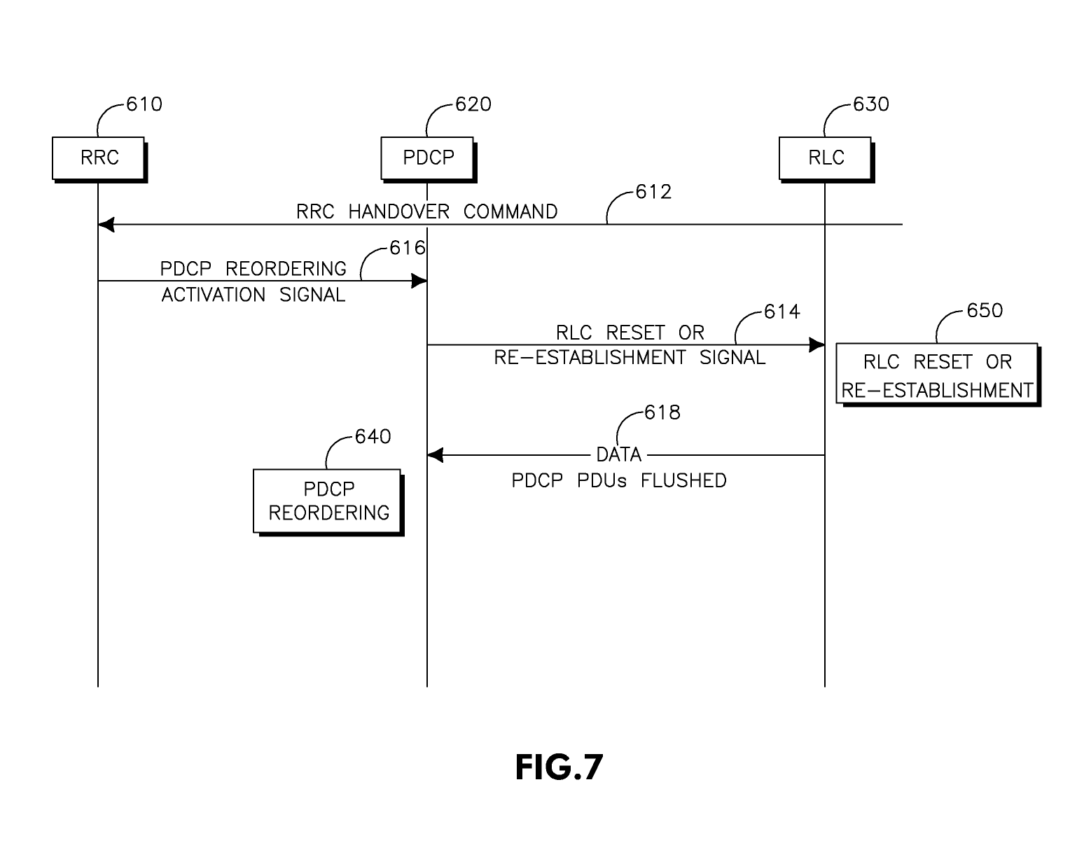

The following is a second embodiment for reordering activation. As shown in FIG. 7, in this embodiment which may be implemented in a device such as the WTRU 900 shown in FIG. 9, the RRC 610 receives the HO Command 612 and sends a Signal 616 (such as a PDCP reordering activation signal) to PDCP. The PDCP 620 then receives the Signal 616 from the RRC 610. This signal activates the PDCP Reordering function 640, which will begin reordering PDCP PDUs as soon as they are received from the RLC 630. The PDCP sends an RLC reset (or re-establishment) Signal 614 to the RLC 630 subsequently invoking an RLC Reset (or re-establishment) 650. The RLC 630 forwards PDCP PDUs in the RLC buffer to the PDCP 620 (such PDCP PDUs may be out of sequence or in sequence) by flushing the RLC buffer at 618. Because the PDCP Reordering function 640 was previously activated, it will immediately begin to reorder the received PDCP PDUs.

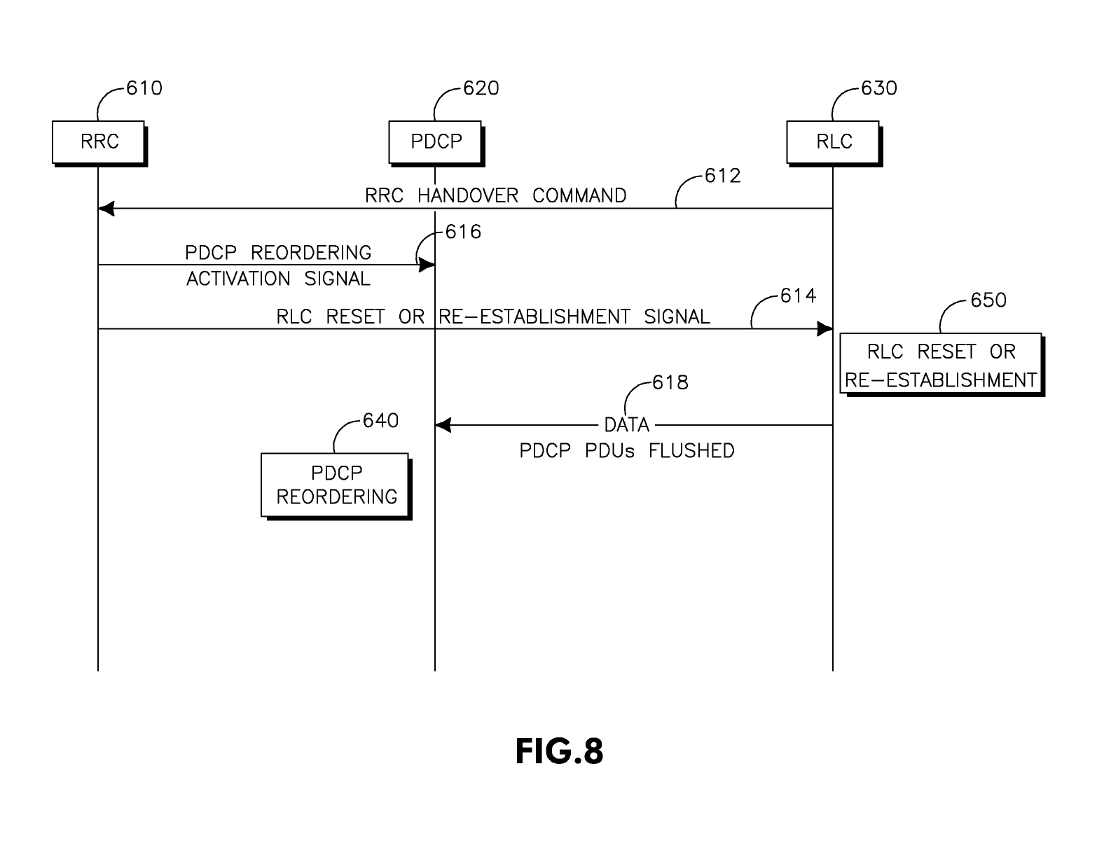

The following is a third embodiment for reordering activation. As shown in FIG. 8, in this embodiment which may be implemented in a device such as the WTRU 900 shown in FIG. 9, the RRC 610 receives the HO Command 612 and sends a Signal 616 (such as a PDCP Reordering Activation Signal) to PDCP. The PDCP 620 then receives the Signal 616 from the RRC 610. This signal activates the PDCP Reordering function 640, which will begin reordering PDCP PDUs as soon as they are received from the RLC 630. In this embodiment, the RRC 610 sends an RLC reset (or re-establishment) Signal 614 to the RLC 630 subsequently invoking an RLC Reset (or re-establishment) 650. The RLC 630 forwards PDCP PDUs in the RLC buffer to the PDCP 620 (such PDCP PDUs may be out of sequence or in sequence) by flushing the RLC buffer at 618. Because the PDCP Reordering function 640 was previously activated, it will immediately begin to reorder the received PDCP PDUs.

The following describes embodiments for PDCP reordering function operations. Other aspects of the PDCP layer described herein may or may not be used with these embodiments. In 3GPP, “Reordering of the downlink RLC SDUs at least during inter-eNB mobility” and “In-sequence delivery of upper layer PDUs at HO” are functions in the PDCP sub-layer. A reordering function may be implemented with two functions or procedures in PDCP:
PDCP SN maintenance: e.g. to detect missing PDCP SN's (i.e. SN gaps)
Timer operations: e.g. to wait for missing PDCP SN's up to a certain time

In one embodiment, when PDCP Reordering is activated at or during handover, and deactivated during ‘normal’ operations, reordering timer operations will work as follows:

During normal operations:
the PDCP reordering function will not wait for missing PDCP SN's (i.e. it will not start a timer) during normal operations;
or the PDCP reordering function will timeout immediately (i.e. zero timer value).

At or during handover,
the PDCP reordering function will wait for missing PDCP SN's (i.e. start a non-zero timer);

In another embodiment, the PDCP Reordering is activated at or during handover, and at other events. This embodiment is similar to the previous embodiment, except that there are other events where reordering is activated (i.e. a reordering timer is started) in addition to HO, such as failure scenarios, or on RLC reset or re-establishment.

In regards to the PDCP SN maintenance function, in one embodiment, the PDCP Reordering function maintains the PDCP SN. In this embodiment, the PDCP reordering function maintains, updates and keeps track of the received PDCP SN (e.g. Rx_PDCP_SN which is the PDCP SN that that the receiver expects to receive next) at all times.

In another embodiment, the PDCP Reordering function does not maintain the PDCP SN. In this embodiment, the PDCP reordering function does not maintain, update or keep track of the received PDCP SN (e.g. Rx_PDCP_SN which is the PDCP SN that that the receiver expects to receive next) at all times; instead, at handover, the expected starting PDCP SN is communicated to the PDCP reordering function, either:
Autonomously or locally in the WTRU for example, as follows:
   starting from the first gap at HO
   or starting from the PDCP SN that was stored in the Rx_PDCP_SN variable at the time of the HO event.
   Or based on RLC receiver and/or HARQ receiver acknowledgment status information
Explicitly (network-assisted): e.g. the HO command indicates the PDCP SN of the first packet that was forwarded from the source eNB to the target eNB

The following describes additional embodiments/variants for PDCP operation. In one embodiment, the HO Command (or any other signaling message) can indicate either the time (starting time) or PDCP SN at which PDCP reordering should be started. For example, the HO Command can indicate the PDCP SN of the first packet that was forwarded (or that will be forwarded) from the source eNB to the target eNB, and such PDCP SN can be used by the WTRU as the starting PDCP SN at which reordering (e.g. reordering timeout operations) can be started.

In another embodiment, the WTRU identifies the packets (i.e. PDCP SN's) that are expected to be transmitted to the target eNB based on the packets that were negatively acknowledged (or not yet acknowledged) by the RLC receiver (or by the HARQ receiver).

In another embodiment, the HO Command (or any other signaling message) may indicate either the time or PDCP SN at which PDCP reordering could be deactivated. For example, the HO Command may indicate the PDCP SN of the last packet that was forwarded (or that will be forwarded) from the source eNB to the target eNB, and such indicated PDCP SN can be used by the WTRU as the starting PDCP SN at which reordering (e.g. reordering timeout operations) can be deactivated. Alternatively, the HO Command can indicate the PDCP SN of the first packet that was sent (or that will be sent) directly from the target eNB (i.e. was not forwarded).

In another embodiment, the PDCP sublayer deactivates (stops) the PDCP reordering functions when all the PDCP SN gaps caused by out-of-order delivery during HO are filled/transmitted (i.e. in the target eNB) (i.e. when the missing packets are received and submitted to upper layers), or when the PDCP reordering function has timed out (i.e. timer has expired).

In another embodiment, reordering may be performed based on the combination of HFN and PDCP SN (i.e. the COUNT), rather than based on PDCP SN only, in order to prevent problems related to having multiple packets in the PDCP receiver buffer that have the same PDCP SN but different HFN, or for any other reason.

Based on the above embodiments, additional embodiments may be constructed.

In a first additional embodiment, upon receiving an indication from RRC or RLC (such as an indication of handover), a WTRU PDCP starts a timer

Upon timer expiry, the WTRU PDCP deactivates reordering.

In a second additional embodiment, the PDCP deactivates the PDCP reordering function when all the PDCP SN gaps caused by out-of-order delivery during HO are filled/transmitted (i.e. when the missing packets are received and submitted to upper layers, e.g. one or more higher layers)

In a third additional embodiment, the PDCP deactivates reordering at the earlier of the two above events (i.e. either condition of embodiments 2 or 3, whichever occurs first).

Additional embodiments determine the anchor or reference PDCP SN and/or HFN to be used in various WTRU operations/functions, such as starting/stopping the PDCP reordering function, updating the PDCP COUNT assignment method, or any other function.

In general, the following approaches may be utilized:
1) WTRU autonomous approaches
2) Network assisted approaches.

In WTRU autonomous based embodiments, the WTRU utilizes local information, possibly with assistance from different layers such as RLC (packet reception) status information and/or HARQ information to determine the PDCP SN and/or HFN that it should use.

In one embodiment, at the WTRU receiver, the RLC sublayer identifies to the PDCP sublayer, the packets (e.g. RLC SDUs) it has successfully acknowledged in its latest RLC status report (e.g. based on the acknowledgement status of the RLC PDUs constituting the SDUs). The latest RLC status report for which a positive HARQ acknowledgment was received could be used to increase the reliability of this scheme. Such information from the RLC will enable the PDCP sublayer, at the receiver, to determine the PDCP SNs that it should expect to receive, due to the forwarding of packets between the eNB's, which will help in deciding when certain PDCP functions (e.g.: reordering) will start or stop.

In the network assisted embodiments, the access network (e.g. eNB) provides indications to assist a WTRU in determining what PDCP SN and/or HFN it should use.

In one embodiment, a signal/message containing a PDCP status report is sent from the eNB to the WTRU indicating the successful “transmission” of PDCP packets to the WTRU (in contrast to a conventional 3GPP report which indicates the successful “reception” of PDCP packets). This PDCP status report will report on which PDCP packets (PDCP SNs) were transmitted successfully to the WTRU (e.g. based on RLC/ARQ and/or HARQ acknowledgement feedback). Alternatively, the report will indicate which PDCP packets (SNs) were NOT transmitted successfully to the WTRU (e.g. based on RLC/automatic repeat request (ARQ) and/or HARQ acknowledgement feedback, or the lack of acknowledgment). Equivalently, the eNB will identify PDCP SN gaps to the WTRU receiver in a message, which in turn can be used for starting or stopping PDCP reordering or in the COUNT assignment function. Such a message can be included in the HO Command for example.

In another embodiment, a signal (e.g. an RRC message such as the HO Command, or any other message) is sent from the eNB to the WTRU indicating which PDCP SN and/or the HFN it should utilize for one or more of the following purposes:
Starting the PDCP reordering function
Stopping the PDCP reordering function
In the COUNT assignment function
   Consequently, the WTRU will re-anchor (i.e. set the values of the Rx_PDCP_SN and/or Rx_HFN PDCP state variables) to new locally-determined or explicitly-signaled values.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

1. A method of packet data convergence protocol (PDCP) processing comprising:
determining a COUNT;
after determining the Count, performing deciphering;
after the performing deciphering, performing header decompression; and
after the performing header decompression, performing duplicate detection and reordering.

2. A method of packet data convergence protocol (PDCP) processing comprising:
performing duplicate detection;
after the performing duplicate detection, determining a COUNT;
after the determining the COUNT, performing deciphering;
after the performing deciphering, performing header decompression; and
after the performing header decompression, performing reordering.

3. A method of packet data convergence protocol (PDCP) processing comprising:
performing duplicate detection in conjunction with determining a COUNT;
after the performing duplicate detection in conjunction with determining the COUNT, performing deciphering;
after the performing deciphering, performing header decompression; and
after the performing header decompression, performing reordering.

4. A method for packet data convergence protocol (PDCP) processing comprising receiving at least one indication to activate a PDCP reordering function.

5. The method of claim 4 wherein the indication further comprises at least one of:
an indication of a handover (HO) message;
an indication that a wireless transmit/receive unit (WTRU) is in an inter-E-UTRAN Node-B (eNB) mobility state;
an indication signifying that a HO is about to occur;
an indication of initiating radio link control (RLC) reset;
an indication of initiating RLC re-establishment;
an indication of RLC flushing;
an indication of RLC forwarding packets in its buffer;
an indication of RLC timing out on at least one missing protocol data unit (PDU);
an indication of RLC receiving a move receive window (MRW) command;
an indication of RLC out-of-sequence delivery;
an indication of suspension of RLC in-sequence delivery;
an indication of RLC out-of-sequence delivery due to HO;
an indication of suspension of RLC in-sequence delivery due to HO;
an indication of RLC out-of-sequence delivery due to reset;
an indication of RLC out-of-sequence delivery due to re-establishment;
an indication of suspension of RLC in-sequence delivery to due to reset; or
an indication of suspension of RLC in-sequence delivery to due to reestablishment.

6. A method of activating and performing packet data convergence protocol (PDCP) reordering comprising:
radio resource control (RRC) receiving a handover (HO) command;
radio link control (RLC) receiving a RLC reset or re-establishment signal from a radio resource control (RRC);
PDCP receiving an activation signal from RLC; and
PDCP activating a PDCP reordering function.

7. A method of activating and performing packet data convergence protocol (PDCP) reordering comprising:
radio resource control (RRC) receiving a handover (HO) command;
RLC receiving a radio link control (RLC) reset or re-establishment signal from a RRC;
PDCP receiving an activation signal from RLC;
PDCP activating a PDCP reordering function;
RLC performing RLC reset or re-establishment;
RLC flushing the RLC buffer;
PDCP receiving at least one PDCP protocol data unit (PDU), and
PDCP performing reordering.

8. A method of activating and performing packet data convergence protocol (PDCP) reordering comprising:
radio resource control (RRC) receiving a handover (HO) command;
RLC receiving a radio link control (RLC) reset or re-establishment signal from a RRC;
RLC performing RLC reset or re-establishment;
PDCP receiving an activation signal from RLC;
RLC flushing the RLC buffer;
PDCP activating a PDCP reordering function;
PDCP receiving at least one PDCP protocol date unit (PDU), and
PDCP performing reordering.

9. A method of activating and performing packet data convergence protocol (PDCP) reordering comprising:
radio resource control (RRC) receiving a handover (HO) command;
PDCP receiving an activation signal from a RRC; and
PDCP activating a PDCP reordering function.

10. A method of activating and performing packet data convergence protocol (PDCP) reordering comprising:
radio resource control (RRC) receiving a handover (HO) command;
PDCP receiving an activation signal from a RRC;
PDCP activating a PDCP reordering function;
radio link control (RLC) receiving a RLC reset or re-establishment signal from the PDCP;
RLC performing RLC reset or re-establishment;
RLC flushing the RLC buffer; and
PDCP receiving at least one PDCP protocol data unit (PDU), and
PDCP performing reordering.

11. A method of activating and performing packet data convergence protocol (PDCP) reordering comprising:
radio link control (RLC) receiving a handover (HO) command;
PDCP receiving an activation signal from a radio resource control (RRC);
PDCP activating a PDCP reordering function;
RLC receiving a radio link control (RLC) reset or re-establishment signal from the RRC;
RLC performing RLC reset or re-establishment;
RLC flushing the RLC buffer;
PDCP receiving at least one PDCP protocol data unit (PDU), and
PDCP performing reordering.

12. A method for packet data convergence protocol (PDCP) reordering comprising:
starting a timer at handover (HO) to wait for at least one missing PDCP sequence number (SN).

13. The method of claim 12 further comprising deactivating PDCP reordering when the timer has expired.

14. The method of claim 12 further comprising:
during normal operations the PDCP reordering function not waiting for a missing PDCP sequence number (SN) via utilizing a zero timer value.

15. A method for activating packet data convergence protocol (PDCP) reordering comprising activating PDCP reordering at an indicated time.

16. The method of claim 15 wherein the value for the time at which to activate reordering is indicated by a message sent from an E-UTRAN Node-B (eNB) to a wireless transmit/receive unit (WTRU).

17. The method of claim 16 wherein the value for the time at which to activate reordering is the time when the message is received by the WTRU.

18. A method for activating packet data convergence protocol (PDCP) reordering comprising activating PDCP reordering at an indicated PDCP sequence number (SN).

19. The method of claim 18, wherein the value for the PDCP SN at which to activate reordering is indicated by a message sent from an E-UTRAN Node-B (eNB) to a wireless transmit/receive unit (WTRU).

20. A method for deactivating packet data convergence protocol (PDCP) reordering comprising deactivating PDCP reordering at an indicated time.

21. The method of claim 20, wherein the value for the time at which to deactivate reordering is indicated by a message sent from an E-UTRAN Node-B (eNB) to a wireless transmit/receive unit (WTRU).

22. A method for deactivating packet data convergence protocol (PDCP) reordering comprising deactivating PDCP reordering at an indicated PDCP sequence number (SN).

23. The method of claim 22, wherein the value for the PDCP SN at which to deactivate reordering is indicated by a message sent from an E-UTRAN Node-B (eNB) to a wireless transmit/receive unit (WTRU).

24. A method for deactivating packet data convergence protocol (PDCP) reordering comprising deactivating PDCP reordering when all missing packets are received and submitted to upper layers.

25. A method for deactivating packet data convergence protocol (PDCP) reordering comprising deactivating PDCP reordering when a timer has expired.

26. A method for deactivating packet data convergence protocol (PDCP) reordering comprising:
deactivating PDCP reordering at the earlier of:
expiration of a timer; or
reception of all missing PDCP packets and submitting the PDCP packets to an upper layer.

27. A method for packet data convergence protocol (PDCP) reordering comprising:
receiving a PDCP packet that includes a PDCP sequence number (SN);
constructing a COUNT value from the PDCP SN and a Hyper Frame Number (HFN); and
reordering PDCP packets based on their associated COUNT values.

28. A wireless transmit/receive device (WTRU) configured to perform packet data protocol convergence (PDCP) processing comprising:
a processor configured to determine a COUNT;
after the processor has determined the COUNT, the processor further configured to perform deciphering;
after the processor has performed deciphering, the processor further configured to perform header decompression; and
after the processor has performed header decompression, the processor further configured to perform duplicate detection and reordering.

29. A wireless transmit/receive device (WTRU) configured to perform packet data protocol convergence (PDCP) processing comprising:
a processor configured to perform duplicate detection;
after the processor has performed duplicate detection, the processor further configured to determine a COUNT;
after the processor has determined the COUNT, the processor further configured to perform deciphering;
after the processor has performed deciphering, the processor further configured to perform header decompression; and
after the processor has performed header decompression, the processor further configured to perform reordering.

30. A wireless transmit/receive device (WTRU) configured to perform packet data protocol convergence (PDCP) processing comprising:
a processor configured to perform duplicate detection in conjunction with determining a COUNT;
after the processor has performed duplicated detection in conjunction with determining the COUNT, the processor further configured to perform deciphering;
after the processor has performed deciphering, the processor further configured to perform header decompression; and
after the processor has performed header decompression, the processor further configured to perform reordering.

31. A wireless transmit/receive device (WTRU) configured to perform packet duplicate detection comprising:
a processor configured to determine if a packet was previously received by checking a packet data convergence protocol (PDCP) buffer;
if the packet was previously received, the processor further configured to discard the packet; and
if the packet was not previously received, the processor further configured to accept the packet.

32. A wireless transmit/receive device (WTRU) configured to perform packet data convergence protocol (PDCP) processing comprising the reception of at least one indication to activate a PDCP reordering function.

33. The WTRU of claim 32, wherein the indication further comprises at least one of:
receiving an indication of initiating radio link control (RLC) reset;
receiving an indication of initiating RLC re-establishment;
receiving an indication of RLC flushing;
receiving an indication of RLC forwarding packets in its buffer;
receiving an indication of RLC timing out on at least one missing protocol data unit (PDU);
receiving an indication of RLC receiving a move receive window (MRW) command;
receiving an indication of RLC out-of-sequence delivery;
receiving an indication of suspension of RLC in-sequence delivery;
receiving an indication of RLC out-of-sequence delivery due to HO;
receiving an indication of suspension of RLC in-sequence delivery due to HO;
receiving an indication of RLC out-of-sequence delivery due to reset;
receiving an indication of RLC out-of-sequence delivery due to re-establishment;
receiving an indication of suspension of RLC in-sequence delivery to due to reset; or
receiving an indication of suspension of RLC in-sequence delivery to due to reestablishment.

34. A wireless transmit/receive unit (WTRU) configured to activate and perform packet data convergence protocol (PDCP) reordering comprising:
a radio resource control (RRC) configured to receive a handover (HO) command;
a radio link control (RLC) configured to receive a RLC reset or re-establishment signal from the RRC;
a PDCP configured to receive an activation signal from the RLC; and
the PDCP configured to activate a PDCP reordering function.

35. A WTRU configured to activate and perform packet data convergence protocol (PDCP) reordering comprising:
a radio resource control (RRC) configured to receive a handover (HO) command;
a radio link control (RLC) configured to receive a RLC reset or re-establishment signal from the RRC;
a PDCP configured to receive an activation signal from the RLC;
the PDCP configured to activate a PDCP reordering function;
the RLC configured to perform RLC reset or re-establishment;
the RLC configured to flush the RLC buffer;
the PDCP configured to receiving at least one PDCP protocol data unit (PDU), and
the PDCP configured to perform reordering.

36. A WTRU configured to activate and perform packet data convergence protocol (PDCP) reordering comprising:
a radio resource control (RRC) configured to receive a handover (HO) command;
a radio link control (RLC) configured to receive a RLC reset or re-establishment signal from the RRC;
the RLC configured to perform RLC reset or re-establishment;
a PDCP configured to receive an activation signal from the RLC;
the RLC configured to flush the RLC buffer;
the PDCP configured to activate a PDCP reordering function;
the PDCP configured to receiving at least one PDCP protocol data unit (PDU); and
the PDCP configured to perform reordering.

37. A wireless transmit/receive unit (WTRU) configured to activate packet data convergence protocol (PDCP) reordering comprising:
a radio resource control (RRC) configured to receive a handover (HO) command;
a PDCP configured to receive an activation signal from the RRC; and
the PDCP configured to activate a PDCP reordering function.

38. A WTRU configured to perform packet data convergence protocol (PDCP) reordering comprising:
a radio resource control (RRC) configured to receive a handover (HO) command;
a PDCP configured to receive an activation signal from a RRC;
the PDCP configured to activate a PDCP reordering function;
a radio link control (RLC) configured to receive a RLC reset or re-establishment signal from the PDCP;
the RLC configured to perform RLC reset or re-establishment;
the RLC configured to flush an RLC buffer; and
the PDCP configured to receive at least one PDCP protocol data unit (PDU); and
the PDCP configured to perform reordering.

39. A WTRU configured to perform packet data convergence protocol (PDCP) reordering comprising:
a radio resource control (RRC) configured to receive a handover (HO) command;
a PDCP configured to receive an activation signal from the RRC;
the PDCP configured to activate a PDCP reordering function;
the radio link control (RLC) configured to receive a RLC reset or re-establishment signal from the RRC;
the RLC configured to perform RLC reset or re-establishment;
the RLC configured to flush an RLC buffer;
the PDCP configured to receive at least one PDCP protocol data unit (PDU); and
the PDCP configured to perform reordering.

40. A WTRU configured to perform packet data convergence protocol (PDCP) reordering comprising:
the WTRU configured to start a timer at handover (HO) to wait for at least one missing PDCP sequence number (SN).

41. The WTRU of claim 40 further configured to deactivate PDCP reordering when the timer has expired.

42. The WTRU of claim 40, wherein, during normal operations, the PDCP reordering function does not wait for a missing packet data convergence protocol (PDCP) sequence number (SN) via the use of a zero timer value.

43. A wireless transmit/receive unit (WTRU) configured to activate packet data convergence protocol (PDCP) reordering at an indicated time.

44. The WTRU of claim 43, wherein the value for the time at which to activate reordering is indicated by a message sent from an E-UTRAN Node-B (eNB) to the WTRU.

45. The WTRU of claim 44 wherein the value for the time at which to activate reordering is the time when the message is received by the WTRU.

46. A WTRU configured to activate packet data convergence protocol (PDCP) reordering comprising the WTRU configured to activate a packet data convergence protocol (PDCP) reordering at an indicated PDCP sequence number (SN).

47. The WTRU of claim 46, wherein the value for the PDCP SN at which to activate reordering is indicated by a message sent from an E-UTRAN Node-B (eNB) to the WTRU.

48. A WTRU configured to deactivate packet data convergence protocol (PDCP) reordering comprising the WTRU configured to deactivate PDCP reordering at an indicated time.

49. The WTRU of claim 48, wherein the value for the time at which to deactivate reordering is indicated by a message sent from an E-UTRAN Node-B (eNB) to the WTRU.

50. A WTRU configured to deactivate packet data convergence protocol (PDCP) reordering comprising the WTRU configured to deactivate PDCP reordering at an indicated PDCP sequence number (SN).

51. The WTRU of claim 50, wherein the value for the PDCP SN at which to deactivate reordering is indicated by a message sent from E-UTRAN Node-B (eNB) to the WTRU.

52. A wireless transmit/receive unit (WTRU) configured to deactivate packet data convergence protocol (PDCP) reordering comprising the WTRU further configured to deactivate PDCP reordering when all missing packets are received and submitted to upper layers.

53. A wireless transmit/receive unit (WTRU) configured to deactivate packet data convergence protocol (PDCP) reordering comprising the WTRU further configured to deactivate PDCP reordering when a timer has expired.

54. A wireless transmit/receive unit (WTRU) configured to deactivate packet data convergence protocol (PDCP) reordering comprising:
the WTRU further configured to deactivate PDCP reordering at the earlier of:
a timer has expired; or
all missing PDCP packets have been received and the PDCP packets have been submitted to an upper layer.

55. A WTRU configured to perform packet data convergence protocol (PDCP) reordering comprising:
the WTRU configured to receive a PDCP packet including a PDCP sequence number (SN);
the WTRU configured to construct a COUNT value from the PDCP SN and a Hyper Frame Number (HFN); and
the WTRU configured to reorder PDCP packets based on their associated COUNT values.
